(19) United States
(12) Patent Application Publication
(10) Pub. No.: US 2026/0361625 A1
(43) Pub. Date: Nov. 12, 2026

(54) QUALITY OF EXPERIENCE (QOE)

(71) Applicant: Nokia Technologies Oy, Espoo (FI)

(72) Inventors: Daniela LASELVA, Klarup (DK); Malgorzata TOMALA, Wroclaw (PL); Chunli WU, Beijing (CN); Jarkko Tuomo KOSKELA, Oulu (FI); Pilar ANDRÉS MALDONADO, Aalborg (DK)

(73) Assignee: Nokia Technologies Oy, Espoo (FI)

(21) Appl. No.: 19/129,851

(22) PCT Filed: Nov. 14, 2022
(86) PCT No.: PCT/CN2022/131749

§ 371 Date: May 14, 2025

(51) Int. Cl. H04L 41/5067; H04W 24/08; H04W 24/10

(52) U.S. Cl. CPC H04L 41/5067; H04W 24/08; H04W 24/10

(57) ABSTRACT

A user equipment comprising means for: making a quality of experience (QoE) measurement; sending to a network a QoE measurement report that is indicative of the QoE measurement; receiving a QoE configuration message from the network indicating at least an event-based trigger; monitoring at least the event-based trigger to trigger one or more of: making a QoE measurement and sending a QoE measurement report that is indicative of a QoE measurement and dependent upon the QoE configuration message.

### TECHNOLOGICAL FIELD

Examples of the disclosure relate to Quality of Experience (QoE).

### BACKGROUND

Quality of Experience (QoE) is a subjective multi-dimensional representation of the satisfaction or annoyance of an end user regarding a service based on explicit and or implicit input from a user.

Currently, in the Third Generation Partnership Project (3GPP) ‘Overall description; Stage-2’ [TS 38.300] Quality of Experience (QoE) measurement and reporting is described in chapter 21 (Application Layer Measurement Collection). QoE measurement collection is supported in RRC_CONNECTED state only. It is noted that QoE Measurement is also referred to as ‘application layer measurement’. The base station (e.g. gNB) requests immediate measurement of service-specific parameters and provides instructions on periodicity of reporting. The user equipment receives the request and immediately measures the service parameters. The user equipment reports measurement of a single service according to the instruction time period. If the UE enters RRC_IDLE state, the UE releases the QoE measurement configuration. RAN visible QoE measurements comprise information readable by the gNB.

It would be desirable to improve Quality of Experience (QoE) monitoring.

### BRIEF SUMMARY

According to various, but not necessarily all, examples there is provided a user equipment comprising means for:
making a quality of experience (QoE) measurement;
sending to a network a QoE measurement report that is indicative of the QoE measurement;
receiving a QoE configuration message from the network indicating at least an event-based trigger;
monitoring at least the event-based trigger to trigger at least one or more of: making a QoE measurement and sending a QoE measurement report that is indicative of a QoE measurement and is dependent upon the QoE configuration message.

In some but not necessarily all examples, the QoE configuration message indicates an event-based trigger for triggering QoE measurement.

In some but not necessarily all examples, the QoE configuration message indicates a periodicity for QoE measurement.

In some but not necessarily all examples, the QoE configuration message indicates an event-based trigger for triggering sending a QoE measurement report.

In some but not necessarily all examples, the QoE configuration message indicates what is measured by the QoE measurement.

In some but not necessarily all examples, the QoE measurements are measurements relating to a standardized telecommunications protocol stack comprising a layered set of protocols that work together to provide a standardized set of telecommunications functions, and do not relate to measurements of a service or services using the standardized telecommunications protocol stack.

In some but not necessarily all examples, the QoE measurements are measurements relating to parameters that when degraded affect QoE, and which can be degraded by a network energy saving feature. In some but not necessarily all examples, the QoE measurements are measurements relating to parameters changed by a network energy saving feature.

In some but not necessarily all examples, the QoE measurements comprise measurement of parameters relating to current and/or future processing capability of the user equipment.

In some but not necessarily all examples, the QoE measurements comprise measurement of changing operating parameters of apparatus.

In some but not necessarily all examples, the QoE measurements comprise measurement of one or more of: energy use, overheating, buffer overflow, latency/delay.

In some but not necessarily all examples, the received QoE configuration message comprises an identifying reference and the QoE measurement report comprises the identifying reference.

In some but not necessarily all examples, the event-based trigger triggers one or more of: making a QoE measurement and sending a QoE measurement report that is indicative of a QoE measurement and the QoE configuration message when an event defined by the event-based trigger is determined to occur, wherein the event is a non-temporal event and/or
relates to a standardized telecommunications protocol stack comprising a layered set of protocols that work together to provide a standardized set of telecommunications functions, and do not relate to a service or services using the standardized telecommunications protocol stack.

In some but not necessarily all examples, the event-based trigger is based on a change in an energy saving feature.

In some but not necessarily all examples, the energy saving feature comprises one or more of a network energy saving feature and/or a UE energy saving feature.

In some but not necessarily all examples, the QoE configuration message is a Configuration message comprising additional attributes relating to QoE.

In some but not necessarily all examples, the QoE configuration message extends the 3GPP RAN visible QoE framework.

In some but not necessarily all examples, the event-based trigger is indicated by the network based on L1/L2 signaling.

In some but not necessarily all examples, the QoE configuration message is a 3GPP RRCReconfiguration message containing an AppLayerMeasConfig Information Element.

In some but not necessarily all examples, a QoE report identifier is included in a RRC message comprising a MeasurementReportAppLayer message.

In some but not necessarily all examples, the making a QoE measurement is configured to make the QoE measurement during an IDLE state and/or during an INACTIVE state.

In some but not necessarily all examples, the user equipment is configured to provide to the network a capability report indicating a capability for event-based QoE measurement and/or configured to provide to the network a capability report indicating a capability for event-based QoE measurement reporting and/or configured to provide to the network a capability report indicating a capability for event-based QoE measurement and/or event-based QoE measurement reporting.

In some but not necessarily all examples, a system comprises the user equipment and at least one network element, wherein the network element is configured to use the QoE measurement report received from the user equipment to select a network configuration option from multiple network configuration options that have or enable different network energy saving.

According to various, but not necessarily all, examples there is provided a method comprising:
making a QoE measurement;
sending to a network a QoE measurement report that is indicative of the QoE measurement;
receiving a QoE configuration message from the network indicating at least an event-based trigger;
monitoring at least the event-based trigger to trigger at least one or more of: making a QoE measurement and sending a QoE measurement report that is indicative of a QoE measurement and is dependent upon the QoE configuration message.

According to various, but not necessarily all, examples there is provided a computer program comprising instructions that when executed by one or more processors causes
making a QoE measurement;
sending to a network a QoE measurement report that is indicative of the QoE measurement;
processing a QoE configuration message received from the network indicating at least an event-based trigger;
monitoring an event-based trigger to trigger at least one or more of: making a QoE measurement and sending a QoE measurement report that is indicative of a QoE measurement and is dependent upon the QoE configuration message.

According to various, but not necessarily all, examples there is provided a network apparatus comprising means for:
sending to a user equipment a quality of experience (QoE) configuration message indicating at least an event-based trigger;
receiving from the user equipment, in dependence upon the event-based trigger, a QoE measurement report that comprises a quality of experience (QoE) measurement made at the user equipment.

In some but not necessarily all examples, the network apparatus comprises means for using the QoE measurement report received from the user equipment to select a network configuration option from multiple network configuration options that have or enable different network energy saving.

In some but not necessarily all examples, the network apparatus comprises means for including an identifying reference in the QoE configuration message sent to the user equipment, means for storing a mapping between the identifying reference and the user equipment, and means for associating a received QoE measurement report with the user equipment based upon the stored mapping.

According to various, but not necessarily all, examples there is provided method comprising:
sending to a user equipment a quality of experience (QoE) configuration message indicating at least an event-based trigger; and
receiving from the user equipment, in dependence upon the event-based trigger, a QoE measurement report that comprises a quality of experience (QoE) measurement made at the user equipment.

According to various, but not necessarily all, examples there is provided computer program comprising instructions that when executed by one or more processors causes: sending to a user equipment a quality of experience (QoE) configuration message indicating at least an event-based trigger; and
receiving from the user equipment, in dependence upon the event-based trigger, a QoE measurement report that comprises a quality of experience (QoE) measurement made at the user equipment.

According to various, but not necessarily all, examples there is provided a user equipment comprising means for:
receive measurement command from network;
monitor event-based trigger to trigger making a measurement delayed from receipt of the measurement command from network;
send report to network dependent upon measurement.

In some but not necessarily all examples, the measurement command is a QoE configuration message, the measurement is QoE measurement and the report is QoE measurement report.

According to various, but not necessarily all, examples there is provided a user equipment comprising means for:
receive QoE configuration message from network;
monitor event-based trigger to trigger making a measurement delayed from receipt of QoE configuration message from network;
send QoE report to network dependent upon measurement.

In some but not necessarily all examples, the measurement is a QoE measurement In some but not necessarily all examples, the QoE configuration message indicates event-based trigger to trigger a QoE measurement and/or event-based trigger to trigger QoE measurement report. In some but not necessarily all examples, the report also dependent upon the QoE configuration message.

According to various, but not necessarily all, examples there is provided a user equipment comprising means for:
receive QoE configuration message from network indicating at least an event-based trigger to trigger a QoE measurement and optionally to trigger a QoE measurement report;
monitor the at least event-based trigger to trigger making a QoE measurement;
send the QoE measurement report to network dependent upon measurement and based on the QoE configuration message.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

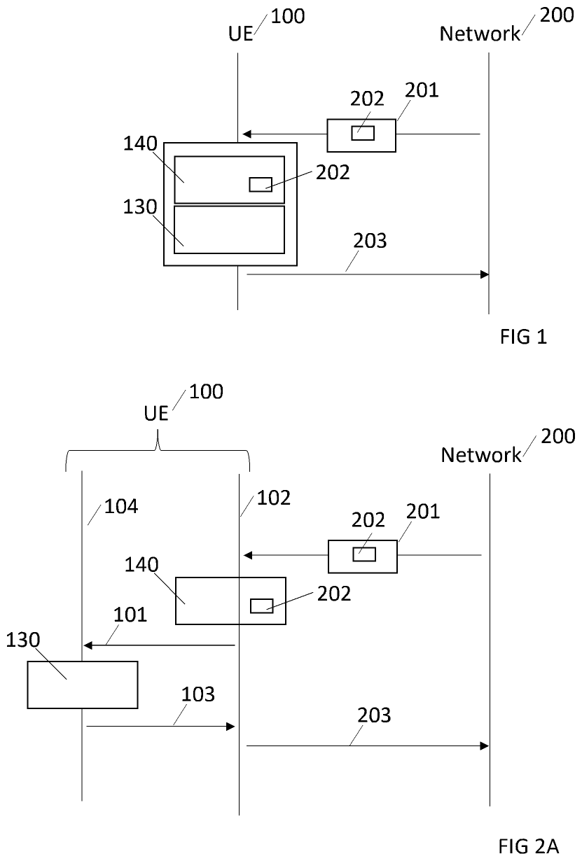

FIG. 1 shows an example of the subject matter described herein;

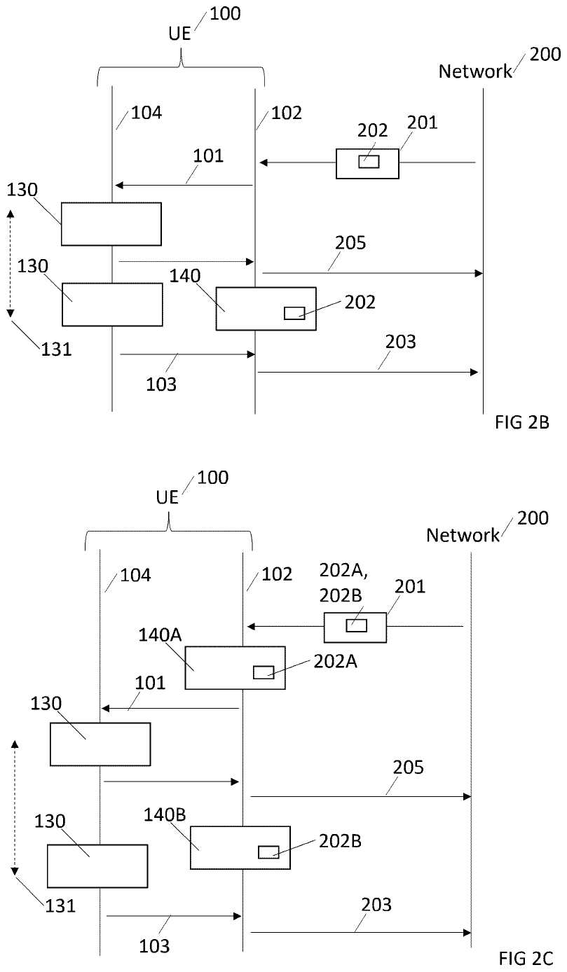

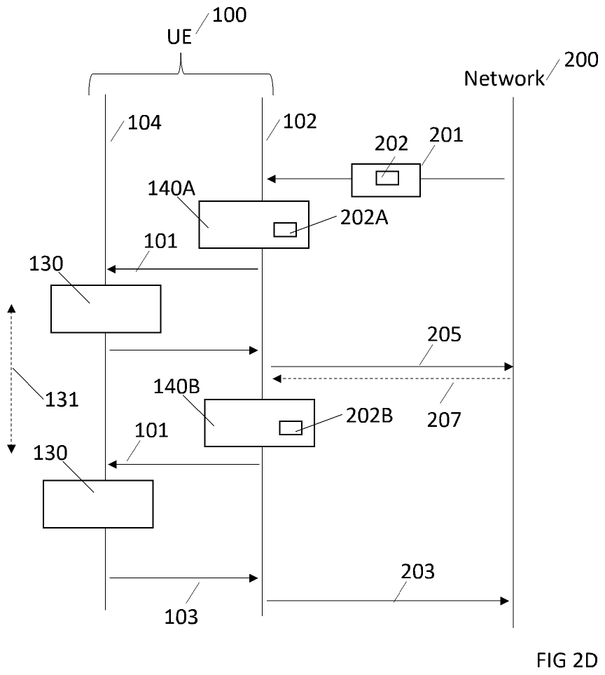

FIG. 2A shows another example of the subject matter described herein;

FIG. 2B shows another example of the subject matter described herein;

FIG. 2C shows another example of the subject matter described herein;

FIG. 2D shows another example of the subject matter described herein;

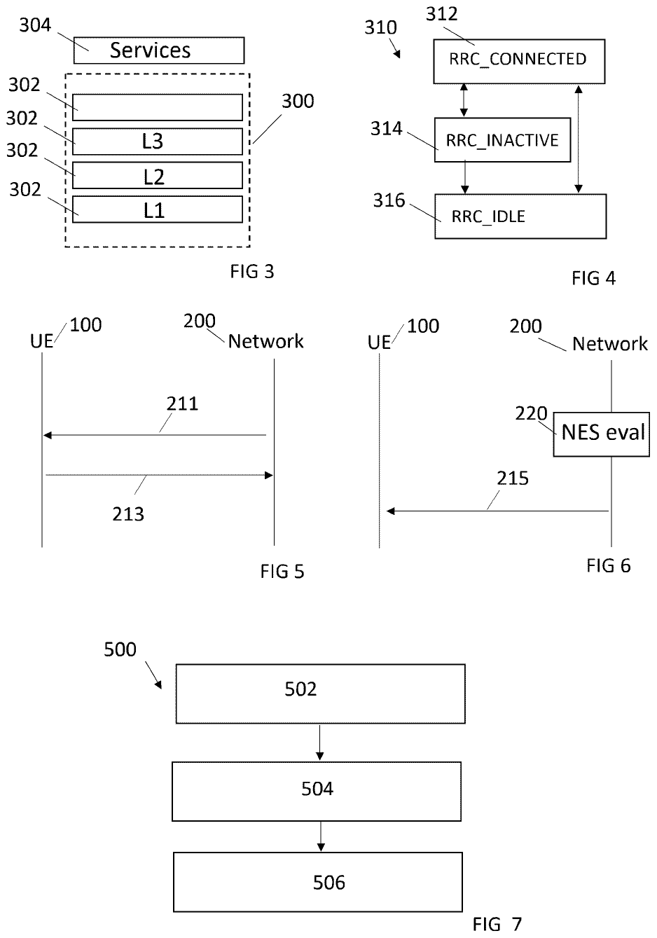

FIG. 3 shows another example of the subject matter described herein;

FIG. 4 shows another example of the subject matter described herein;

FIG. 5 shows another example of the subject matter described herein;

FIG. 6 shows another example of the subject matter described herein;

FIG. 7 shows another example of the subject matter described herein;

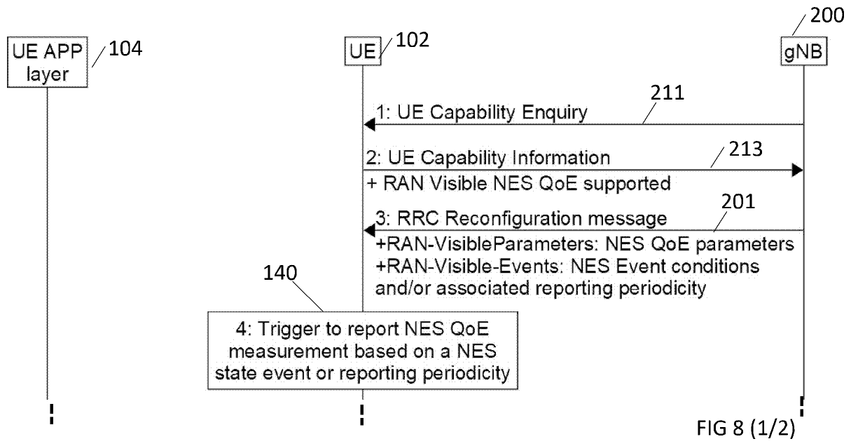

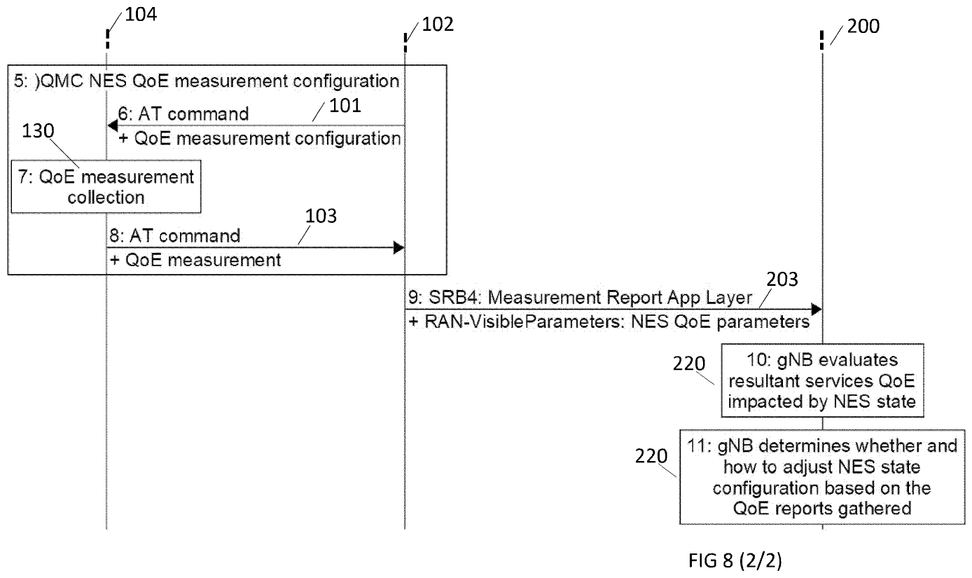

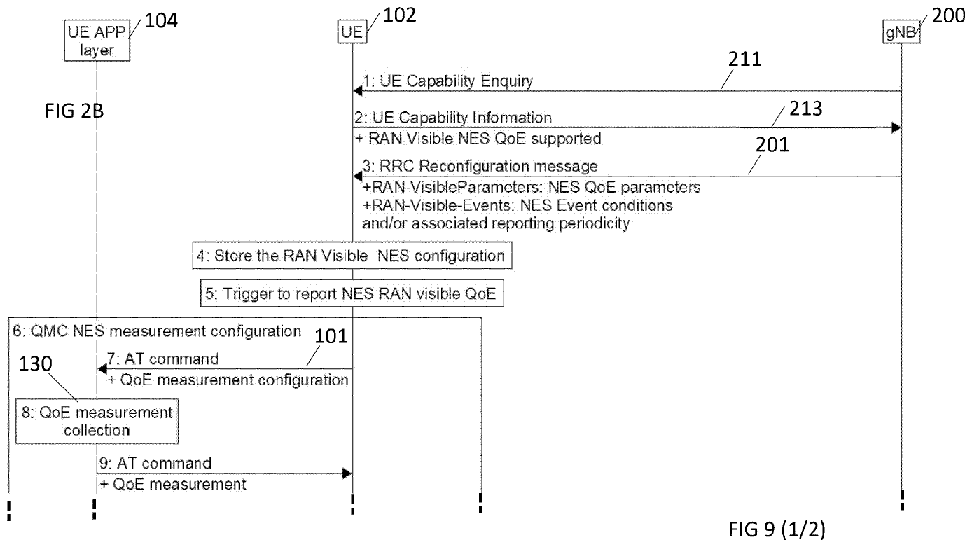

FIG. 8 shows another example of the subject matter described herein;

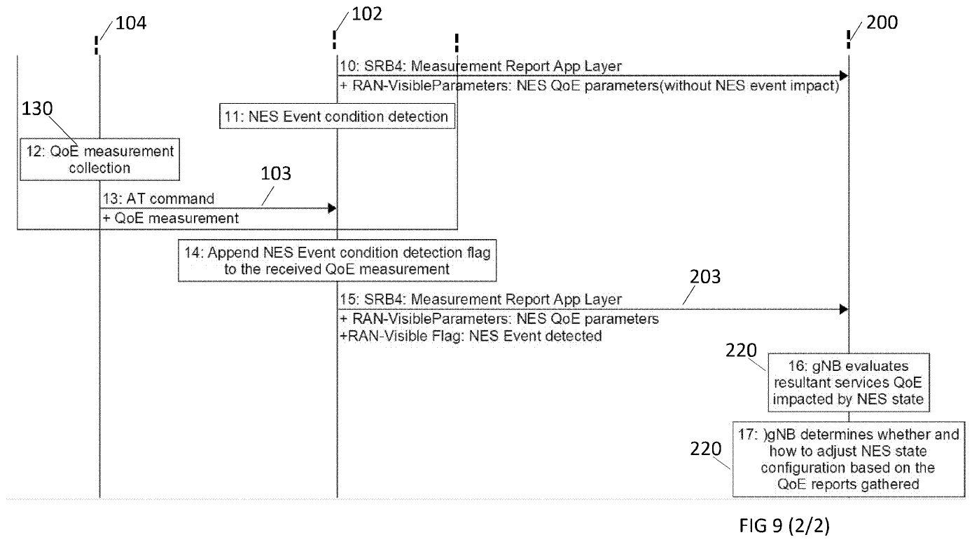

FIG. 9 shows another example of the subject matter described herein.

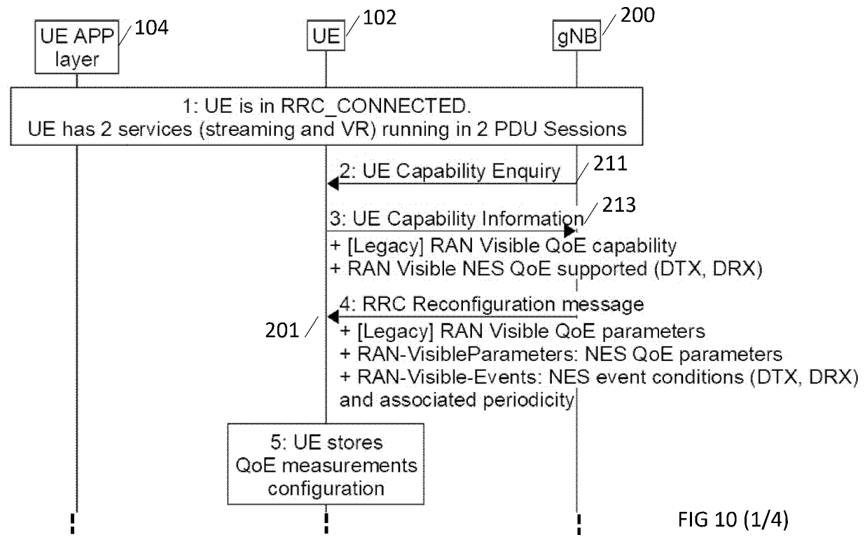

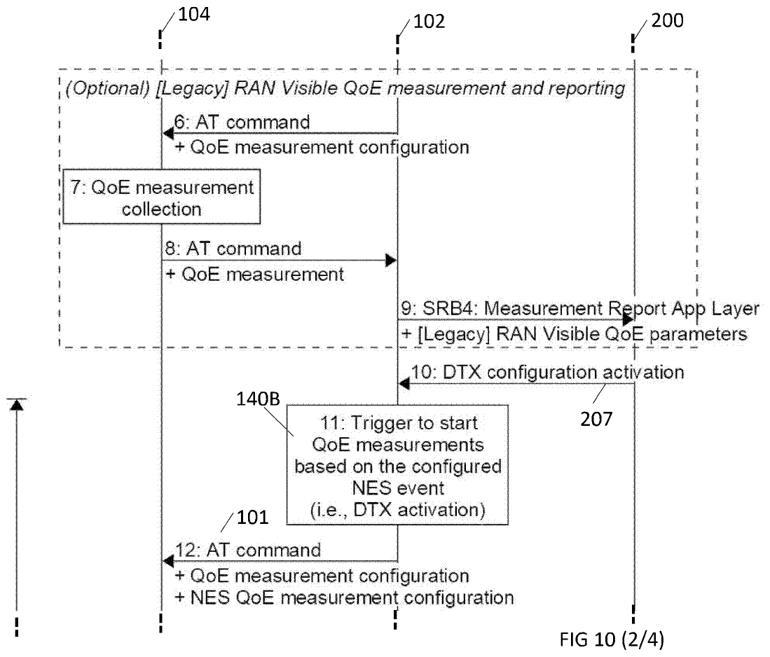

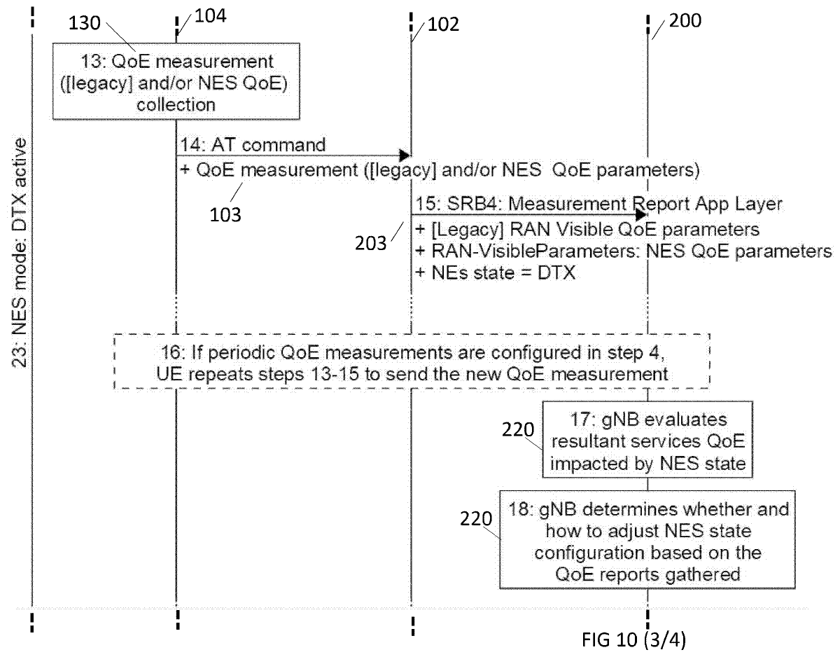

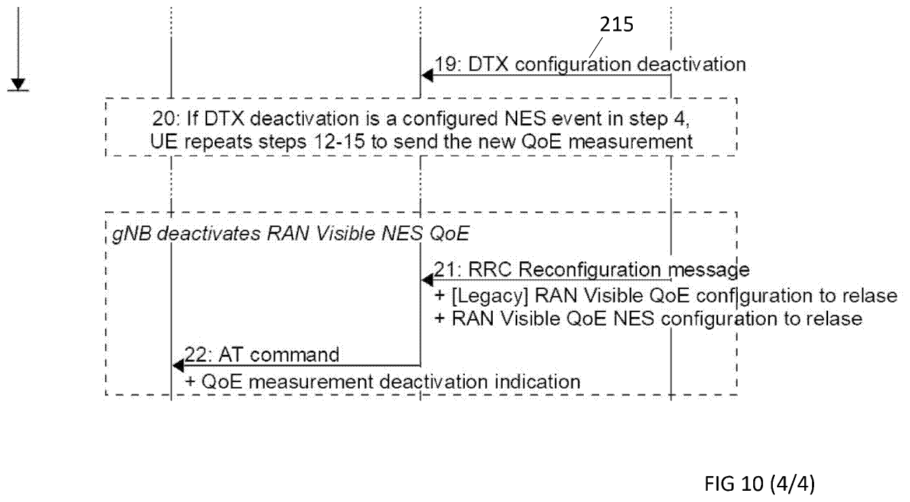

FIG. 10 shows another example of the subject matter described herein;

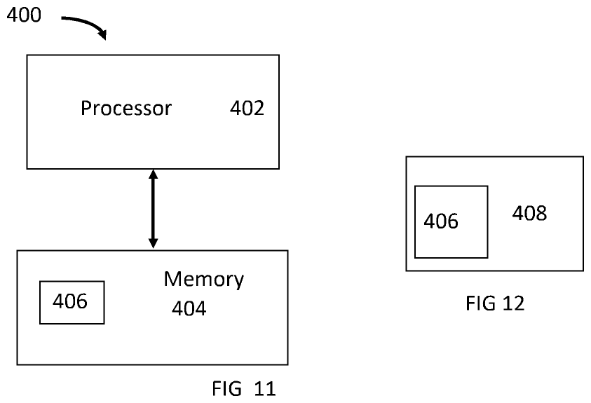

FIG. 11 shows another example of the subject matter described herein.

FIG. 12 shows another example of the subject matter described herein

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all FIG.

### DEFINITIONS

3GPP: Third Generation Partnership Project.

RAN: Radio Access Network, for example a base station such as eNodeB (eNB) or gNodeB (gNB).

Control plane: The part of a network which carries information necessary to establish and control the network. It is often used to describe the flow of information packets between network interfaces when illustrating control of a network.

NR: New radio, also known as 5G.

UTRA is Universal Terrestrial Radio Access and UTRAN is Universal Terrestrial Radio Access. UTRA relates to the air interface of 3GPP. E-UTRA is evolved UTRA and describes the air interface used by an eNodeB and a gNodeB.

Protocol stack: Layered set of protocols which work together to provide a set of functions.

Telecommunications protocol stack: Layered set of protocols which work together to provide a set of telecommunications functions.

Standardized telecommunications protocol stack: a telecommunications protocol stack defined by a telecommunications standard.

3GPP telecommunications protocol stack: a standardized telecommunications protocol stack defined by a 3GPP telecommunications standards. The radio protocol between the UE and the RAN node (eNodeB or gNodeB), and the protocol stack including the protocol stack for the control plane, is specified in the E-UTRA & E-UTRAN; ‘Overall description; Stage 2’ (TS 36.300) and the NR ‘Overall description; Stage-2’ in TS 38.300.

Service: functionality that uses a protocol stack.

Quality of Service (QoS): The set of performance parameters that can be directly observed and measured and are relevant to delivery of one of multiple services. Can include parameters for: latency, bit rate, packet error rate, etc.

Quality of Experience (QoE): subjective multi-dimensional representations of the satisfaction or annoyance of the end user regarding a service based on explicit and or implicit input from a user.

Radio Resources measurements (RRM) are objective measurements relating to a radio environment e.g. RSRP, RSRQ, SINR, RSSI based on RS or other signals.

Network Energy saving (NES) is set of features performed at the network for the purpose of reducing energy consumption. It can, for example, involve the selection of an option from multiple options based on greater network energy saving.

RRC: Radio Resource Control is a radio resource control plane protocol for radio resource management.

RRC_CONNECTED state: The UE has an established RRC connection.

RRC_IDLE state: The UE has no established RRC connection.

RRC_INACTIVE state: The UE has a suspended, established RRC connection.

### DETAILED DESCRIPTION

FIG. 1 illustrates an example of a radio telecommunications system comprising a network 200 and a terminal apparatus 100. The network 200 and the terminal apparatus 100 communicate via exchange of radio signals. In this example, but not necessarily all examples, the terminal apparatus is user equipment 100.

The network 200 is configured to send a measurement command 201 to the user equipment (UE) 100.

The UE 100 is configured to receive the measurement command 201 from the network 200; monitor 140 an event-based trigger 202 to trigger 140 making 130 a measurement delayed from receipt of the measurement command 201 from the network 200; and send a report 203 to the network 200 dependent upon the measurement.

The report 203 to the network 200 can for example be indicative of the measurement. For example, the report 203 can comprise the measurement. This may be the measurement as measured or a value determined from the actual measurement or based on the actual measurement.

In at least some examples, the measurement command 201 is a QoE configuration message, the measurement is QoE measurement and the report 203 is QoE measurement report.

In at least some examples, the measurement command 201 indicates the event-based trigger 202 to trigger 140 a QoE measurement and/or an event-based trigger to trigger a QoE measurement report 203.

In at least some examples, the report 203 is also dependent upon the measurement command 201 (QoE configuration message). For example, in at least some examples, the report 203 comprises an indicator provided by the measurement command 201 (QoE configuration message).

Using event-based measurement, so that measurement is delayed and not immediate, decouples the measurement from the receipt of the measurement command 201.

Using event-based reporting decouples the reporting from the receipt of the measurement command 201 and/or the measurement itself.

It will be appreciated that in some examples, the user equipment 100 comprises means for: receiving a QoE configuration message 201 from the network 200; monitoring 140 an event-based trigger 202 to trigger making 130 a measurement delayed from receipt of the QoE configuration message 201 from the network 200; sending a QoE measurement report 203 to the network 200 that is dependent upon the measurement. The measurement can be a QoE measurement. The QoE configuration message indicates an event-based trigger to trigger a QoE measurement and/or an event-based trigger to trigger a QoE measurement report. The report is also dependent upon the QoE configuration message 201.

FIGS. 2A, 2B. 2C and 2D illustrate examples of a user equipment 100 comprising means for:
making 130 a quality of experience (QoE) measurement;
sending to a network 200 a QoE measurement report 203 that is dependent upon the QoE measurement;
receiving a QoE configuration message 201 from the network indicating at least an event-based trigger 202;
monitoring 130 at least the event-based trigger 202 to trigger one or more of:
   (i) making 130 a QoE measurement and
   (ii) sending a QoE measurement report 203 that is dependent upon a QoE measurement and the QoE configuration message 201.

The QoE measurement report 203 can, for example, comprise the QoE measurement.

FIG. 2A illustrates a user equipment 100 comprising means for:
making 130 a quality of experience (QoE) measurement;
sending to a network a QoE measurement report 203 that is dependent upon the QoE measurement;
receiving a QoE configuration message 201 from the network 200 indicating at least an event-based trigger 202;
monitoring 140 at least the event-based trigger 202 to trigger making a QoE measurement.

The event-based trigger 202 determines when QoE measurement occurs. The QoE configuration message 201 indicates an event-based trigger 202 for triggering QoE measurement.

FIG. 2B illustrates user equipment 100 comprising means for:
making 130 a quality of experience (QoE) measurement;
sending to a network 200 a QoE measurement report 203 that is dependent upon the QoE measurement;
receiving a QoE configuration message 201 from the network 200 indicating at least an event-based trigger 202;
monitoring 140 at least the event-based trigger 202 to trigger sending a QoE measurement report that is dependent upon a QoE measurement and the QoE configuration message.

The QoE measurement report 203 can, for example, comprise the QoE measurement

The event-based trigger 202 does not necessarily determine when QoE measurement occurs. The QoE configuration message 201 can for example indicates a periodicity 131 for QoE measurement.

The event-based trigger 202 determines when QoE measurement report 203 occurs. The QoE configuration message 201 indicates an event-based trigger 202 for triggering sending a QoE measurement report 203.

FIGS. 2C and 2D illustrate a user equipment comprising means for:
making 130 a quality of experience (QoE) measurement;
sending to a network 200 a QoE measurement report 203 that is dependent upon the QoE measurement;
receiving a QoE configuration message 201 from the network 100 indicating at least a first event-based trigger 202A and a second event-based trigger 202B;
monitoring 140A a first event-based trigger 202A to trigger making a QoE measurement.
monitoring 140B a second event-based trigger 202B to trigger sending a QoE measurement report 203 that is dependent upon a QoE measurement and the QoE configuration message 201.

The QoE measurement report 203 can, for example, comprise the QoE measurement.

The event-based trigger 202 determines when QoE measurement occurs. The QoE configuration message 201 indicates an event-based trigger 202A for triggering QoE measurement.

The event-based trigger 202 determines when QoE measurement report 203 occurs. The QoE configuration message 201 indicates an event-based trigger 202B for triggering sending a QoE measurement report 203.

Thus in at least some examples, a user equipment 100 comprises means for:
receiving a QoE configuration message 201 from a network 200 indicating at least an event-based trigger 202 to trigger a QoE measurement and optionally to trigger a QoE measurement report;
monitoring 140 the at least event-based trigger 202 to trigger making a QoE measurement;
sending the QoE measurement report 203 to the network dependent upon the measurement and based on the QoE configuration message 201.

In some but not necessarily all examples, the QoE configuration message 201 comprises an identifying reference and the QoE measurement report 203 comprises the identifying reference. For example, each QoE measurement configuration can be uniquely identified by a QoE reference.

In some but not necessarily all examples, the QoE configuration message 201 indicates what is measured by the QoE measurement.

QoE measurements are typically subjective multi-dimensional representations of the satisfaction or annoyance of end user regarding a service, where the multiple dimensions (e.g. device, content/service, environment, user expectations, personality) are weighted by the end user (the user of the user equipment 100). One of the dimensions that influences QoE can be the radio environment (and Radio Resource Management (RRM) measurements). A new additional class of QoE attributes are used that relate to the user equipment (not the service) and its hardware performance. The RRM measurements are limited to represent the radio environment by its objective metrics (RSRP, RSRQ, SINR, RSSI based on reference signals or other signals).

In some but not necessarily all examples, the QoE measurements comprise measurement of parameters relating to current and/or future processing capability of the user equipment. For example the user equipment battery level, UE operating temperature, setup time, buffer level, QOS (latency, data rate, packet loss). Thus the QoE measurements comprise a measurement of changing operating parameters of the user equipment 100.

In some but not necessarily all examples, the QoE measurements are measurements relating to parameters that when degraded affect QoE, and which can be degraded by network energy saving (NES) procedures.

In some but not necessarily all examples, the user equipment 100 comprises a UE modem layer 102 and an application layer 104 as illustrated in FIGS. 2A to 2D.

The UE modem layer 102 performs external communication with the network 200 and internal communication with the application layer 104. The application layer 104 does not communicate directly with the network 200.

For example, the UE modem layer 102 sends an attention (AT) message 101 to the application layer 104 and receives in reply an attention (AT) message 193 from the application layer 104. The attention (AT) message 101 causes the making 130 of the QoE measurement. The attention (AT) message 103 comprises that QoE measurement.

For example, the UE modem layer 102 receives the QoE configuration message 201 via a radio interface between the modem layer 102 and the network 200 and the the UE modem layer 102 sends the QoE measurement report 203 via the radio interface between the modem layer 102 and the network 200. The QoE measurement report 203 can comprise the QoE measurement received in the attention (AT) message 103.

The UE modem layer 102 represents a standardized telecommunications protocol stack. As illustrated in FIG. 3, a protocol stack 300 comprises multiple protocol layers 302 arranged as a layered set that work together to provide a set of functions. A standardized telecommunications protocol stack 300 comprises a layered set of protocols 302 that work together to provide a standardized set of telecommunications functions. In at least some examples, the standardized telecommunications protocol stack 300 is a 3GPP telecommunications protocol stack.

The service layer 304 is separate from the protocol stack 300. The services can use the standardized telecommunications protocol stack 300.

In at least some examples, the QoE measurements are measurements relating to the standardized telecommunications protocol stack 300 and are not measurements relating to a service or services 304. The QoE measurements are measurements that are independent of the services 304.

The event-based trigger 202 triggers one or more of:
i) making 130 a QoE measurement and
ii) sending a QoE measurement report 203 that is dependent upon a QoE measurement and the QoE configuration message,
when a trigger event defined by the event-based trigger is determined to occur by the user equipment 100.

The trigger event can, for example, be a non-temporal event. A non-temporal event is an event that is not determined solely by the passage of time. For example, triggering at a specific time or at specific times or every period of time are temporal events.

The trigger event can, for example, relate to a standardized telecommunications protocol stack (and not relate to a service or services using the standardized telecommunications protocol stack).

The trigger event can, for example, be a change in an energy saving feature. In this case, the user equipment 100 informs the network 200 of an impact on QoE, at the user equipment 100, caused by energy saving. The energy saving feature can comprises one or more of a network energy saving (NES) feature and/or a UE energy saving feature.

The trigger event can, for example, be a change to a different network energy saving (NES) state. The trigger event can, for example, be a change to a different RRC state, for example changing between RRC_CONNECTED, RRC_IDLE, RRC_INACTIVE.

The trigger event can, for example, be a change in the configuration of the air interface (UTRA).

In at least some examples, the QoE configuration message is a configuration message comprising additional attributes relating to QoE. For example, new attributes can be added to an existing message. The new attributes can control one or more of: what is measured, when it is measured (event-based trigger) and when it is reported (event-based trigger).

In at least some examples the QoE configuration message 201 extends the 3GPP RAN visible QoE framework.

In at least some examples, the event-based trigger 202 is indicated by the network 200 based on L1/L2 signaling.

In at least some examples, the QoE configuration message 202 is a 3GPP RRCReconfiguration message comprising an AppLayerMeasConfig Information Element and the QoE measurement report is a RRC message comprising a MeasurementReportAppLayer message.

FIG. 4 illustrates a state machine 310 for a terminal node 100 e.g. user equipment. The state machine 310 comprises three different states: connected state 312, inactive state 314 and idle state 316.

In the example illustrated, the terminal node 110 is user equipment and the states are RRC connected state 312, RRC inactive state 314 and RRC idle state 316. In the particular example illustrated, the terminal node 110 is New Radio (NR) user equipment and the states are NR RRC connected state 312, NR RRC inactive state 314 and NR RRC idle state 316.

The states and transitions between the states are defined in the appropriate specifications.

The inactive state 314 can, in this example, only be entered from the connected state 312 e.g. via radio resource control (RRC) release with suspend message. The inactive state can, in this example, be exited to the connected state via a RRC Resume or exited to the idle state via a RRC Release.

The RRC Release message with suspend is an RRC Release message that includes the suspend configuration information. It is a downlink message.

The inactive state 314 is a state that has a first set of characteristics that are common with the idle state 316 but not the connected state 312 and a second set of characteristics that are common with the connected state 312 but not the idle state 316.

In at least some examples, the first set of characteristics comprise mobility management by cell re-selection and the second set of characteristics comprise a security context for ciphering.

Data transmission is possible in the connected state 312 and the inactive state 314. The inactive state 314 can, for example, support small data transmission.

The above described event-triggered QoE measurement can occur in the connected state 312, the inactive state 314 and the idle state 316 or as a result of transitions between states.

The above described event-triggered QoE measurement reporting can occur in the connected state 312 and the inactive state 314 but not the idle state 316 or as a result of transitions to the connected state 312 or the inactive state 314.

FIG. 5 illustrates UE capability reporting in the system previously described. The user equipment 100 is configured to provide to the network 200 a capability report 213. The capability report 213 can, for example, indicate a capability for event-based QoE measurement or a capability for event-based QoE measurement reporting or a capability for event-based QoE measurement and/or event-based QoE measurement reporting.

In this example, the user equipment 100 is configured to provide to the network 200 a capability report 213 in response to reception of a capability request message 211 sent by the network 200.

FIG. 6 illustrates the system as previously described. It illustrates operations at the network 200 after it receives the QoE measurement report 203.

The network element 200 is configured to use the QoE measurement report 203, received from the user equipment 100, to select a network configuration option from multiple available network configuration options that have or enable different network energy saving.

The network 200 can, for example, be configured to optimize power saving while respecting constraints imposed by the QoE measurement report 203. In some examples, the network 200 can, for example, be configured to select the option that both provides a QoE at the UE 100 that exceeds a minimum threshold and exceeds a minimum power saving. In some examples, the network 200 can, for example, be configured to select the option that both provides a QoE at the UE 100 that exceeds a minimum threshold and also provides maximum network power saving.

FIG. 7 illustrates an example of a method 500.

The method comprises at block 502 receiving a QoE configuration message from the network indicating at least an event-based trigger.

The method comprises at block 504 monitoring at least the event-based trigger to trigger one or more of: making a QoE measurement and sending a QoE measurement report that is dependent upon a QoE measurement and the QoE configuration message.

The method comprises at block 506 making the QoE measurement and sending the QoE measurement report.

A number of use cases will now be described with reference to the preceding FIGs. These use cases relate to enhancements for network energy savings (NES) in NR. NES reduce the energy consumption of mobile networks, and particularly of the RAN, which consumes the largest part of the total energy consumption in the network.

As previously described the Quality of Experience (QoE) represents the overall quality or performance of a provided service as perceived subjectively by the user.

Within 3GPP specifications, QoE Measurement Collection (QMC) is part on the 5G standard since Rel-17. The overall framework enables the collection of QoE measurements generated at UE's Application layer.

In RAN Visible QoE, the network 200 is a gNB. The QoE measurements are configured by the gNB. A subset of QoE metrics is reported from the UE 100 as an explicit Information Element (IE) readable by the gNB 200. The set of available RAN visible QoE metrics is a subset of the metrics which are already configured as part of QoE measurement configuration encapsulated in the transparent container.

In the following use cases, the 3GPP radio protocol stack is referred as ‘UE’ or ‘UE layer’ as per typical 3GPP naming and as per QoE Measurement Collection from Chapter 21 of TS 38.300.

The examples combine Network Energy Saving (NES) and QoE measurements. To enable this, QoE measurements that are currently associated to only user plane services (e.g., DASH, VR) are extended to control plane configurations that impact QoE.

Most of the power saving techniques (device or network side technique) may degrade the experience the user of the UE 100 has with the network 200, and as a result it may result in lower QoE. This is because the activation of power saving techniques may lead to a degraded Quality of Service (QoS) that the network 200 can offer to the user (in terms of data rate, latency, etc.), which in turn may impact the QoE. For example, the latency, reliability or bandwidth may degrade if the UE 100 or the network 200 are in or starting from a sleep mode (e.g. the inactive state).

The gNB 200 is the entity controlling the energy saving techniques to apply, the QoE measurement reports 203 allow the gNB 200 to know how NES impacts QoE.

The use cases allow the gNB 200 to be made aware of the impact of (network) energy savings on the UE's QoE.

The gNB 200 retrieves NES (Network Energy Saving) related QoE metrics from the UE 100, via QoE measurement reports 203, to evaluate how one or more NES techniques may impact the user's QoE. The NES specific QoE measurement reports allow the network 200 to optimize the decision of whether, when, and where (in which cells) to activate a given NES technique with the aim to minimize/avoid the QoE impact for the end-user.

New RAN visible QoE reporting triggers can, for example, be associated to the NES state of the cell/beam that the UE monitors/is served from. That is, the measurement and/or reporting from UE side may be triggered based on a given NES state, e.g. if the gNB is in/moves to/exits from a given NES state.

The gNB 200 is responsible for configuring, deactivating and releasing the QoE measurement related to NES, including configuring, at the UE 100, the NES specific triggers for the NES dedicated QoE measurements/logging and/or NES specific report triggers.

In one example, a NES specific QoE measurement, if configured, is performed only if the network 200 is in the corresponding NES state.

The triggers can be event-based (e.g., an event can be defined due to the network 200 changing to a different NES state and/or the UE 100 changing to a different RRC state, and/or a reconfiguration of the air interface).

Different triggering can be configured for different NES states, e.g. only need to trigger the report when NES state is expected to be unable to satisfy the UE's QoS requirement.

The RAN visible QoE framework is extended also for UEs in RRC_INACTIVE and RRC_IDLE. That is, the UE 100 while in RRC idle/inactive should perform and store certain QoE measurements, and should report them based on the gNB configuration. The UE 100 can perform QoE measurements in idle/inactive state. The QoS measurement report 203 can be sent via Small Data Transfer (SDT) during the RRC_INACTIVE state. Specific QoE attributes can be defined for UE in Idle/Inactive.

New QoE attributes related to NES can be used. The attributes can be split into the new metrics required for QoE measurement, and/or metrics associated with NES event triggering the RAN visible QoE reports collection.

For example:
UE battery status (at start and stop time of a QoE logging): indication of the battery consumption through a period of time, e.g. when the UE 100 has to camp in a cell for monitoring paging and at the same time monitor a different dormant cell for UL transmission. Such indication can be provided along with screen time duration.

Device heating/overheating information.

Initial setup time: How long it takes for the UE to access a service when a NES technique is activated (e.g. cell switch off, on-demand activation of a dormant cell). UE Buffer level associated with NES mode status: indication of the UE Buffer level when a NES technique is activated (dormant cell/beam).

Experienced QoS derived by UE (in terms of latency, data rate, packet loss): the UE can report information about the experienced QoS when a NES state is activated along with the corresponding NES state associated to. For example, network Discontinuous Transmission (DTX) can impact delays seen by the UE 100. Using QoE measurement reports 203 the network 200 can determine how much QoS is impacted due to NES. This could be useful particularly for UEs in RRC idle/inactive state for which the QoS monitoring cannot be performed by the network.

The measurements may be common to all PDU sessions of the UE.

The use cases are based on (and extend) the RAN visible QoE configuration framework. The existing signaling framework is reused and the New QoE attributes are added. For example, as per existing signaling, the RAN visible QoE is configured together with a container based QoE, and an RRC identifier can be assigned to each of the measurement configurations.

The following terminology is used in the use cases to differentiate between two types of QoE measurements referred to as ‘legacy QoE’ and ‘NES QoE’:
‘Legacy QoE’ measurements including legacy attributes/parameters: These include service-specific QoE parameters/attributes already available in the specifications. Following release-17 operations, the reporting of these QoE parameters is periodic. ‘NES QoE’ measurements including new NES-based attributes/parameters and/or new NES specific triggering: The NES specific QoE attributes/parameters proposed in this solution. In addition to periodic reporting, NES QoE parameters shall be event-based enabled (e.g., measured/reported when a NES mode is activated or deactivated).

Note, there may be deployments where the legacy QoE and NES QoE parameters are configured in a way that the gNB can evaluate how the services the UE is running (e.g., streaming, VR) are impacted by NES configuration, or there may be deployments the gNB is only interested in NES QoE parameters.

The gNB 200 can use the NES-triggered/NES-based QoE reports 203 gathered by the gNB 200 based on local gNB implementation to evaluate whether NES impacts QoE, and determine how to maintain the QoE of the UEs it serves when using NES.

For example, the gNB 200 could prioritize one service over another one to avoid the QoE degradation of a priority service while still being able to use a NES state. Additionally or alternatively, the gNB could change the UE configuration or allocated resources in order to avoid QoE degradation, and while still being able to use a NES state. As an example, it can assign more Physical Resource Blocks (PRBs) in the frequency domain to compensate for reduced time allocation due to a NES state e.g. in the time domain. Additionally or alternatively, the gNB can deactivate a NES feature or avoid activating the NES feature if that is deemed to cause QoE degradation for a given UE, whenever the UE is active.

Also service or UE pre-emption could be used by starving another low priority service or releasing a low-priority UE.

Additionally or alternatively, the gNB could change the UE configuration (e.g. C-DRX configuration for optimizing the time-domain resources, and/or the BWP configuration for optimizing the frequency-domain resources) or may allocate a larger amount of resources when serving the UE (e.g. by assigning more PRBs in the frequency domain to compensate for reduced time allocation due to a NES state) in order to avoid QoE degradation, and while still be able to use a NES state in the time domain.

A fist use case relates to RAN visible QoE for NES: configuration and reporting. The QoE measurement is controlled by event-based triggering.

The first use case is illustrated in FIG. 8, which includes features from FIGS. 5, 2A & 6.

As illustrated in FIGS. 5 & 8 , the network 200 sends a UE Capability Enquiry 211 to the UE 100 (Step 1 of FIG. 8). The UE 100 replies with UE Capability Information which includes an indication of RAN Visible NES QoE support (Step 2 of FIG. 8).

As illustrated in FIGS. 2A & 8, the network 200 sends to the UE 100 a RRC Reconfiguration message comprising as RAN Visible parameters: NES QoE parameters and comprising as RAN Visible-Events: NES Event conditions (Step 3 of FIG. 8). It can also include associated reporting periodicity. The RRC Reconfiguration message is a QoE measurement command 202 because it includes NES QoE parameters (for measurement) and/or NES Event conditions (for event-based triggering).

The UE 100 monitors 140 an event-based trigger 202 to trigger making 130 a NES QoE measurement delayed from receipt of the measurement command 201 from the network 200 (Step 4 of FIG. 8). In response to detecting the event-based trigger the UE sends AT command 101 comprising a QoE measurement configuration (Step 6 of FIG. 8). The UE 100 performs QoE measurement collection 130 (Step 7 of FIG. 8). The UE sends AT command 103 comprising the QoE measurement (Step 8 of FIG. 8).

The UE 100 sends a QoE measurement report 203 to the network (gNB 200) (Step 9 of FIG. 8). For example a signal radio bearer (SRB) e.g. SRB4 can provide a Measurement Report App Layer and RAN-VisibleParameters: NES QoE parameters.

As illustrated in FIGS. 6 & 8 , the gNB 200 evaluates 220 resultant services that are QoE impacted by NES state (Step 10 of FIG. 8). The gNB 200 determines whether and how to adjust NES state configuration based on the QoE measurement reports 203 gathered (Step 11 of FIG. 8).

A second use case relates to an alternative implementation of RAN visible QoE for NES: configuration and reporting. The sending of a QoE measurement report is controlled by event-based triggering.

The second use case is illustrated in FIG. 9, which includes features from FIGS. 5, 2B & 6.

In this example, there is continued reporting of the QoE metrics from before and after NES event detection.

The gNB 200 configures the UE 100 with the NES mode-specific QoE measurement report triggering while the UE 100 has no NES event detection at initial phase of data collection. The configuration provided by the gNB is activated through AT command to trigger data reporting regardless of NES event condition. The configuration for NES event condition detection is stored and monitored in the UE 100. Upon detection of the NES event, the UE 100 continues data collection 130, but additionally append the information on the NES event detection in the reported data in the QoE measurement report 203.

As illustrated in FIGS. 5 & 9 , the network 200 sends a UE Capability Enquiry 211 to the UE 100 (Step 1 of FIG. 9). The UE 100 replies with UE Capability Information which includes an indication of RAN Visible NES QoE support (Step 2 of FIG. 9).

As illustrated in FIGS. 2B & 9, the network 200 sends to the UE 100 a RRC Reconfiguration message comprising as RAN Visible parameters: NES QoE parameters and comprising as RAN Visible-Events: NES Event conditions (Step 3 of FIG. 9). It can also include associated reporting periodicity. The RRC Reconfiguration message is a QoE measurement command 202 because it includes NES QoE parameters (for measurement) and/or NES Event conditions (for event-based triggering).

The UE 100 stores the RAN Visible NES configuration (Step 4 of FIG. 9). The UE immediately measures 130 and reports 205 the NES RAN visible QoE (not based on a NES state event) and thereafter periodically measures 130 and reports 205 the NES RAN visible QoE (not based on a NES state event) (Step 5 & 6 of FIG. 9).

The UE sends AT command 101 comprising a QoE measurement configuration (Step 7 of FIG. 9). The UE 100 performs QoE measurement collection 130 (Step 8 of FIG. 9). The UE sends AT command 103 comprising the QoE measurement (Step 9 of FIG. 9).

The UE 100 sends a QoE measurement report 203 to the network (gNB 200) (Step 10 of FIG. 9). For example a signal radio bearer (SRB) e.g. SRB4 can provide a Measurement Report App Layer and RAN-VisibleParameters: NES QoE parameters (without NES event impact).

Periodically, the UE 100 performs QoE measurement collection 130 and sends AT command 103 comprising the QoE measurement (Step 12 & 13 of FIG. 9).

The UE 100 monitors 140 an event-based trigger 202 to trigger making 130 a NES QoE measurement delayed from receipt of the measurement command 201 from the network 200 (Step 11 of FIG. 9). The event-based trigger is a NES Event condition.

In response to detecting the event-based trigger the UE 100 appends NES event condition detection flag to a received QoE measurement (Step 14 of FIG. 9).

The UE 100 sends a QoE measurement report 203 to the network (gNB 200) (Step 15 of FIG. 9). For example a signal radio bearer (SRB) e.g. SRB4 can provide a Measurement Report App Layer and RAN-VisibleParameters: NES QoE parameters (without NES event impact) and RAN-Visible Flag: NES Event detected.

As illustrated in FIGS. 6 & 9 , the gNB 200 evaluates 220 resultant services that are QoE impacted by NES state (Step 16 of FIG. 9). The gNB 200 determines whether and how to adjust NES state configuration based on the QoE measurement reports 203 gathered (Step 17 of FIG. 9).

A third use case relates to an alternative implementation of RAN visible QoE for NES: configuration and reporting. The QoE measurement is controlled by event-based triggering and the sending of a QoE measurement report is controlled by event-based triggering.

The third use case is illustrated in FIG. 10, which includes features from FIGS. 5, 2D & 6.

This use case relates to network discontinuous transmission/reception, DTX/DRX, in which the network 200 may suspend/discard any transmission/reception during a given (short) period such as a few tens of ms. In this example, the gNB 200 configures the UE 100 with the NES mode (DTX/DRX) specific QoE measurements and/or NES mode-specific QoE reporting triggering while the UE 100 has two user plane services running (i.e. service 1 and service 2). The goal of the QoE measurements to be gathered at the gNB 200 from the UE 100 is to determine how the activation/usage of the given NES mode (DTX/DRX) is impacting the QoE of the services the UE 100 is running while in RRC_CONNECTED. Therefore, the legacy QoE measurements at PDU Session level (reported 205 by the UE 100) can be analyzed at the gNB together with the proposed NES related QoE measurements (reported 203 by the UE 100). To enable this, NES related (different) triggers for reporting are needed. First, based on a detected 140B NES-related event 202B (such as activation or deactivation of DTX), and second, periodic reporting while the NES mode is active (to be able to learn the evolution of the service satisfaction while the NES mode is active).

The QoE measurement reports 203 can be used at the network 200 to determine for example whether network DTX/DRX can be applied when either service is running. The decision of whether to apply network DTX/DRX taken based on the received QoE measurement reports could be applied during the subsequent part of the UE's session, after the QoE reports 203 are received, or during a future connection of the same UE (e.g. information of the QoE impact from NES can be stored in the UE context), or for a connection of a different UE asking for the same service. For example, if (a significant) QoE degradation is noticed based on the QoE report for service 1 but not for service 2, the network can activate network DTX/DRX only when service 2 is running but not service 1.

Referring to FIG. 5 and FIG. 10:
Step 1: The UE 100 is in RRC_CONNECTED mode and has running two user plane services (streaming and VR in this example) in 2 PDU Sessions.
Steps 2 and 3: gNB 200 learns the UE capabilities for RAN visible QoE measurement configuration. For that, the UE indicates 213 its support of the legacy QoE measurements (as already available in the specification for example for streaming or VR services) and additionally of the NES QoE measurements.

Referring to FIG. 2D and FIG. 10:
Step 4: gNB 200 configures 201 the UE 100 with the RAN visible QoE measurements (parameters and triggers for reporting). Two subsets of parameters can be requested:
Legacy RAN visible QoE parameters (service specific): For example, the number of buffer level entries or the playout delay for media startup.

NES QoE parameters: For example, the trigger events 202A, 202B.
Step 5: The UE 100 stores the QoE measurements configuration requested by the gNB 200.
Steps 6 to 9: The UE initiates 101 a QoE measurement 130 for the legacy RAN visible QoE parameters the gNB requested in step 4. This QoE measurement is reported 205 and can be used at the gNB 200 as a reference QoE the UE 100 had when the NES mode is not used.
Step 10: The gNB 200 activates 207 network DTX.
Step 11: The UE 100 identifies a trigger 202B for NES QoE measurements due to the NES related event (i.e., DTX activation) according to the configuration the gNB provided in step 4.
Steps 12-15: The UE 100 initiates 101 a QoE measurement 130 and report for the legacy RAN visible QoE parameters and/or the NES QoE parameters the gNB requested in step 4. Together with the QoE measurement, the UE indicates the NES state in the QoE measurement report 203.
Step 16: If the gNB provided QoE measurement configuration in step 4 included reporting periodicity, the UE will initiate and report QoE measurements periodically.

Referring to FIG. 6 and FIG. 10:
Step 17-18: Based on the retrieved NES related QoE measurements from the UE 100, the gNB 200 can determine if the trade off between user experience and power saving is good enough to further exploit/employ one or more NES techniques or instead prioritize the QoS configuration to improve the UE's services performance.
Step 19: The gNB deactivates DTX.
Step 20: If the gNB provided QoE measurement configuration in step 4 included a DTX deactivation event trigger, the UE initiates a QoE measurement and report due to a NES related event (i.e., DTX deactivation).
Steps 21 and 22: The gNB deactivates the QoE measurement configuration.

The above solutions can be used to provide further analysis and fine tuning of the QOS at the 5G core network, if the gNB reports the QoE related to NES and associated NES configuration to the core/OAM.

FIG. 11 illustrates an example of a controller 400 suitable for use in an apparatus 100 or 200. Implementation of a controller 400 may be as controller circuitry. The controller 400 may be implemented in hardware alone, have certain aspects in software including firmware alone or can be a combination of hardware and software (including firmware).

As illustrated in FIG. 11 the controller 400 may be implemented using instructions that enable hardware functionality, for example, by using executable instructions of a computer program 406 in a general-purpose or special-purpose processor 402 that may be stored on a computer readable storage medium (disk, memory etc) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus 100 when loaded into the processor 402. The computer program instructions, of the computer program 406, provide the logic and routines that enables the apparatus to perform the methods illustrated in the accompanying Figs. The processor 402 by reading the memory 404 is able to load and execute the computer program 406.

The apparatus 100 comprises:
at least one processor 402; and
at least one memory 404 including computer program code
the at least one memory 404 and the computer program code configured to, with the at least one processor 402, cause the apparatus 100 at least to perform:
making a QoE measurement;
sending to a network a QoE measurement report that is dependent upon the QoE measurement;
processing a QoE configuration message received from the network indicating at least an event-based trigger;
monitoring an event-based trigger to trigger one or more of: making a QoE measurement and sending a QoE measurement report that is dependent upon a QoE measurement and the QoE configuration message.

The apparatus 100 comprises:
at least one processor 402; and
at least one memory 404 including computer program code,
the at least one memory storing instructions that, when executed by the at least one processor 402, cause the apparatus at least to perform:
making a QoE measurement;
sending to a network a QoE measurement report that is dependent upon the QoE measurement;
processing a QoE configuration message received from the network indicating at least an event-based trigger;
monitoring an event-based trigger to trigger one or more of: making a QoE measurement and sending a QoE measurement report that is dependent upon a QoE measurement and the QoE configuration message.

As illustrated in FIG. 12, the computer program 406 may arrive at the apparatus 100 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 100 may propagate or transmit the computer program 406 as a computer data signal.

Computer program instructions for causing an apparatus to perform at least the following or for performing at least the following:
making a QoE measurement;
sending to a network a QoE measurement report that is dependent upon the QoE measurement;
processing a QoE configuration message received from the network indicating at least an event-based trigger;
monitoring an event-based trigger to trigger one or more of: making a QoE measurement and sending a QoE measurement report that is dependent upon a measurement and the QoE configuration message.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/ dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

As used here ‘module’ refers to a unit or apparatus that excludes certain parts/components that would be added by an end manufacturer or a user. The UE 100 can be a module. The UE modem 102 can be a module.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “ determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. A user equipment comprising:
at least one processor; and,
at least one memory having stored thereon instructions that, when executed by the at least one processor, cause the user equipment to at least perform:
making a quality of experience (QoE) measurement;
sending to a network a QoE measurement report that is indicative of the QoE measurement;
receiving a QoE configuration message from the network indicating at least an event-based trigger;
monitoring at least the event-based trigger to trigger at least one or more of: making a QoE measurement and sending a QoE measurement report that is indicative of a QoE measurement and is dependent upon the QoE configuration message.

2. A user equipment as claimed in claim 1, wherein the QoE configuration message indicates an event-based trigger for triggering QoE measurement.

3. A user equipment as claimed in claim 1, wherein the QoE configuration message indicates a periodicity for QoE measurement.

4. A user equipment as claimed in claim 1, wherein the QoE configuration message indicates an event-based trigger for triggering sending a QoE measurement report.

5. A user equipment as claimed in claim 1, wherein the QoE configuration message indicates what is measured by the QoE measurement.

6. A user equipment as claimed in claim 1, wherein the QoE measurements are measurements relating to a standardized telecommunications protocol stack comprising a layered set of protocols that work together to provide a standardized set of telecommunications functions, and do not relate to measurements of a service or services using the standardized telecommunications protocol stack.

7. A user equipment as claimed in claim 1, wherein the QoE measurements are measurements relating to parameters changed by a network energy saving feature.

8. A user equipment as claimed in claim 1, wherein the QoE measurements comprise measurement of parameters relating to current and/or future processing capability of the user equipment.

9. A user equipment as claimed in claim 1, wherein the QoE measurements comprise measurement of changing operating parameters of apparatus.

10. A user equipment as claimed in claim 1, wherein the QoE measurements comprise measurement of one or more of:
energy use, overheating, buffer overflow, latency/delay.

11. A user equipment as claimed in claim 1, wherein the received QoE configuration message comprises an identifying reference and the QoE measurement report comprises the identifying reference.

12. A user equipment as claimed in claim 1, wherein the event-based trigger triggers one or more of: making a QoE measurement and sending a QoE measurement report that is indicative of a QoE measurement and the QoE configuration message when an event defined by the event-based trigger is determined to occur, wherein the event is
a non-temporal event and/or
relates to a standardized telecommunications protocol stack comprising a layered set of protocols that work together to provide a standardized set of telecommunications functions, and do not relate to a service or services using the standardized telecommunications protocol stack.

13. A user equipment as claimed in claim 1, wherein the event-based trigger is based on a change in an energy saving feature.

14. (canceled)

15. A user equipment as claimed in claim 1, wherein the QoE configuration message is a Configuration message comprising additional attributes relating to QoE.

16. A user equipment as claimed in claim 1, wherein the QoE configuration message extends the 3GPP RAN visible QoE framework.

17. A user equipment as claimed in claim 1, wherein the event-based trigger is indicated by the network based on L1/L2 signaling.

18. A user equipment as claimed in claim 1, wherein the QoE configuration message is a 3GPP RRCReconfiguration message containing an AppLayerMeasConfig Information Element.

19. A user equipment as claimed in claim 1, wherein a QoE report identifier is included in a RRC message comprising a MeasurementReportAppLayer message.

20. A user equipment as claimed in claim 1, wherein the making a QoE measurement is configured to make the QoE measurement during an IDLE state and/or during an INACTIVE state.

21. A user equipment as claimed in claim 1, wherein the user equipment is configured to provide to the network a capability report indicating a capability for event-based QoE measurement and/or configured to provide to the network a capability report indicating a capability for event-based QoE measurement reporting and/or configured to provide to the network a capability report indicating a capability for event-based QoE measurement and/or event-based QoE measurement reporting.

22-29. (canceled)
